(19) United States
(12) Patent Application Publication
(10) Pub. No.: US 2023/0040219 A1
(43) Pub. Date: Feb. 9, 2023

(54) SYSTEM AND METHOD FOR HANDS-FREE MULTI-LINGUAL ONLINE COMMUNICATION

(71) Applicant: DEYAN ALEX, Foster City, CA (US)

(72) Inventor: Deyan Alex, Foster City, CA (US)

(21) Appl. No.: 17/883,173

(22) Filed: Aug. 8, 2022

Related U.S. Application Data
(60) Provisional application No. 63/231,232, filed on Aug. 9, 2021.

(51) Int. Cl. H04M 1/60; G06F 3/16; G06F 40/58

(52) U.S. Cl. CPC H04M 1/6041; G06F 3/167; G06F 40/58

(57) ABSTRACT

According to various embodiments, a method for hands-free multi-lingual online communication between a first mobile device and a second mobile device is disclosed. The method comprises receiving, at the first mobile device, a text input message in a second language from the second mobile device associated with a second user. Further, the method comprises determining whether a preferred language selection for communicating with the second user on the first mobile device is associated with a language different than the second language. Further, the method comprises translating the received text input message into the first language for a first user of the first mobile device. Furthermore, the method comprises displaying the text input message into the first language on the first mobile device.

### FIELD OF THE INVENTION

This invention relates to hands-free multilingual online communication, and in particular, a computer-implemented system and method for facilitating real-time language translation during online social networking.

### BACKGROUND OF THE INVENTION

In the current internet era and globalization, social networking and online communication with people of different ethnicity and locations is required. However, the interaction among people over the globe has a natural language barrier. To facilitate the interaction among people, there exist a few solutions providing text and audio translation. Such solutions include systems based on automatic speech recognition and machine translation.

However, in such current conventional solutions, no real-time text and/or audio translation is provided for online communication. Even currently used mobile chat applications do not provide any facility for text/audio messages translation from one language to another language. Additionally, none of the existing solutions are able to provide a methodology for providing real-time language translation from audio to text messages or vice-versa.

Accordingly, there is a need for a solution for providing seamless methodology for online communication accessible to users via their mobile device. Additionally, there is a need for providing a methodology to enable users to have a multi-lingual hands-free communication via their mobile devices.

### SUMMARY OF THE INVENTION

This summary is provided to introduce a selection of concepts, in a simplified format, that are further described in the detailed description of the invention. This summary is neither intended to identify key or essential inventive concepts of the invention and nor is it intended for determining the scope of the invention.

The present invention seeks to provide a solution to all the above stated problems by providing a hands-free multilingual online communication, and in particular, a computer-implemented system and method for facilitating real-time language translation during online social networking.

According to one embodiment of the present disclosure, a method for hands-free multi-lingual online communication between a first mobile device and a second mobile device is disclosed. The method comprises receiving, at the first mobile device, a text input message in a second language from the second mobile device associated with a second user. Further, the method comprises in response to receiving the text input message from the second mobile device associated with the second user, determining, by the first mobile device, whether a preferred language selection for communicating with the second user on the first mobile device is associated with a language different than the second language. Further, the method comprises in response to determining that the preferred language selection is associated with a first language which is different from the second language, translating the received text input message into the first language for a first user of the first mobile device. Furthermore, the method comprises displaying the text input message into the first language on the first mobile device. Additionally, the method comprises in response to receiving a verbal command of a plurality of predefined verbal commands from the first user, outputting a voice message corresponding to the text input message from the first mobile device.

According to another embodiment of the present disclosure, a method for hands-free multi-lingual online communication among a plurality of users in a group chat window of a mobile application is disclosed. The method comprises receiving, via a user interface of the mobile application, a text input message in a first language from a first mobile device associated with a first user. Further, the method comprises in response to receiving the text input message from the first mobile device associated with the first user, determining, via one of the mobile application or a server associated with the mobile application, whether a preferred language selection for communicating in the group chat window for a second user on the second mobile device is associated with a language different than the first language. Furthermore, the method comprises in response to determining that the preferred language selection is associated with a second language which is different from the first language, translating the received text input message into the second language for the second user of the second mobile device. Additionally, the method comprises displaying, via a user interface of the mobile application at the second device, the text input message into the second language. Moreover, the method comprises displaying, via a user interface of the mobile application at the first device, the text input message into the first language.

According to yet another embodiment of the present disclosure, a system for hands-free multi-lingual online communication between a first mobile device and a second mobile device is disclosed. The system comprises a memory comprising computer executable instructions, and a processor configured to execute the computer executable instructions to: receive, at the first mobile device, a text input message in a second language from the second mobile device associated with a second user; in response to receipt of the text input message from the second mobile device associated with the second user, determine, by the first mobile device, whether a preferred language selection for communicating with the second user on the first mobile device is associated with a language different than the second language; in response to a determination that the preferred language selection is associated with a first language which is different from the second language, translating the received text input message into the first language for a first user of the first mobile device; display the text input message into the first language on the first mobile device; and in response to receipt of a verbal command of a plurality of predefined verbal commands from the first user, output a voice message corresponding to the text input message from the first mobile device.

According to yet another embodiment of the present disclosure, a system for hands-free multi-lingual online communication among a plurality of users in a group chat window of a mobile application is disclosed. The system comprises a memory comprising computer executable instructions; and a processor configured to execute the computer executable instructions to: receive, via a user interface of the mobile application, a text input message in a first language from a first mobile device associated with a first user; in response to receipt of the text input message from the first mobile device associated with the first user, determine, via one of the mobile application or a server associated with the mobile application, whether a preferred language selection for communicating in the group chat window for a second user on the second mobile device is associated with a language different than the first language; in response to a determination that the preferred language selection is associated with a second language which is different from the first language, translating the received text input message into the second language for the second user of the second mobile device; display, via a user interface of the mobile application at the second device, the text input message into the second language; and display, via a user interface of the mobile application at the first device, the text input message into the first language.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

Some embodiments of the present invention are illustrated as an example and are not limited by the figures or measurements of the accompanying drawings, in which like references may indicate similar elements and in which:

FIG. 1 depicts a system for hands-free multi-lingual online communication, in accordance with the various embodiments of the present invention.

FIG. 2 illustrates a block diagram depicting an architecture for implementing a hands-free multi-lingual online communication system in a mobile device, in accordance with some embodiments of the present invention.

FIGS. 3a-3b depict a flow diagram illustrating a method of operation of hands-free multi-lingual online communication system, in accordance with various embodiments of the present invention.

FIGS. 4a and 4b illustrate exemplary user interfaces of the hands-free multi-lingual online communication system implemented at a mobile device, in accordance with various embodiments of the present invention;

FIG. 5 illustrates an exemplary cloud architecture for implementation of for hands-free multi-lingual online communication, in accordance with some embodiments of the present invention;

FIG. 6 illustrates an exemplary computer program product that is configured to provide hands-free multi-lingual online communication, in accordance with various embodiments of the present invention;

FIG. 7 is a block diagram illustrating an exemplary computing device that is configured to provide hands-free multi-lingual online communication, in accordance with various embodiments of the present invention;

FIG. 8 provides a system for hands-free multi-lingual online communication among a plurality of users in a group chat window of a mobile application, according to an embodiment of the present invention; and

FIG. 9 illustrates flow diagram 900 depicting a method 900 for hands-free multi-lingual online communication among a plurality of users in a group chat window of a mobile application, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF DRAWINGS

The present invention will now be described by referencing the appended figures representing preferred embodiments.

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

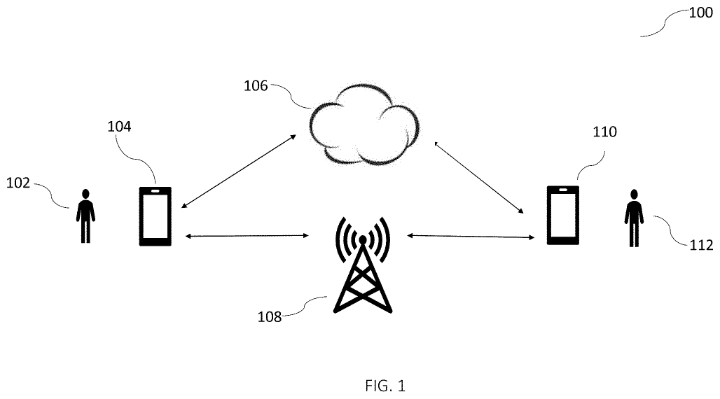

FIG. 1 depicts a system 100 for hands-free multi-lingual online communication, in accordance with the various embodiments of the present invention. In accordance with the various embodiments of the present invention, the system 100 may include mobile devices 104 and 110, cloud architecture 106, and a mobile network 108.

According to one embodiment of the present invention, each of the mobile devices 104 and 110 may include an application installed therein. The application may comprise computer processor executable instructions, which upon execution, are configured to provide a hands-free multi-lingual online communication with another mobile device (or user of the mobile device). In another embodiment, the hands-free multi-lingual online communication may be configured to be accessed via a website available through a web-browser on the mobile devices 104/110. While the Figure depicts the mobile devices 104 and 110, it may be apparent to a person skilled in the art that the mobile devices 104 and 110 may include any electronic communication device capable of installation of a mobile application or running a web browser to access internet. For example, the mobile devices 104 and 110 may include, but not limited to, a mobile communication device, a laptop, a desktop, smart watch, tablet, etc.

The application installed at the mobile device 104/110 may be configured to store a plurality of verbal commands for a user 102/112 of the respective devices. The plurality of verbal commands may be configured as a part of initial voice training for the application, upon initial installation. For example, the user 102 may be prompted via a user interface of the mobile device 104 to provide exemplary voice commands in order to train the application for recognizing user 102's voice commands in future. In one exemplary embodiment, the user may be prompted to provide verbal commands for sending a message by speaking “<<Device Name>> SEND.” Similarly, other verbal commands, such as, but not limited to, “<<Device Name>> READ” may be prompted for and set by the application. The device name may be separately set by the user 102. Further, the user 102 may be prompted to speak each command in a plurality of tones for better training of the application. Based on receiving each of the plurality of verbal commands from the user in a plurality of tones, the application may be configured to store these verbal commands in a memory to match the user's voice commands provided during hands-free communication via the application. Each of the verbal commands may be associated with an action to be performed on the mobile application associated with the chat or text/verbal messages. For example, the “<<Device Name>> SEND” may be associated with sending the message to another user.

In an embodiment of the present invention, the plurality of verbal commands may be dynamically updated by the user. In particular, the application would facilitate modifying the verbal commands at any time. For example, the user may modify the “Device name” as well as use an alternative command such as “TRANSMIT” instead of “SEND.”

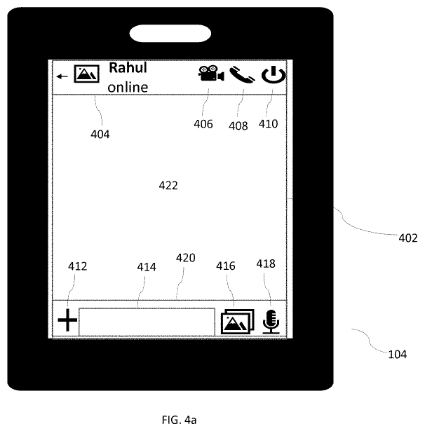

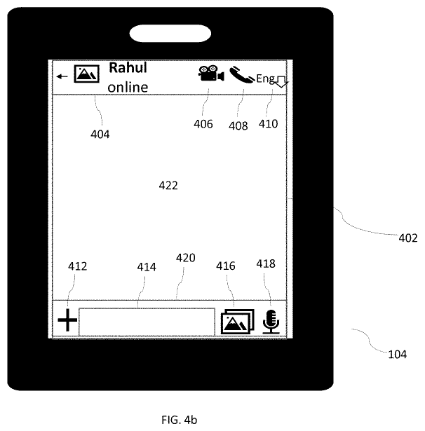

Further, the application installed at the mobile devices 104/110 may be configured to prompt, via the user interface, to receive a preferred language selection from the users 102/112. The user interface of the mobile devices 104/110 may display a list of available languages pre-stored at the application. In response to displaying the list, the users 102/112 may select their respective preferred languages. For example, the user 102 may select “English” via the user interface of the mobile device 104, while the user 112 may select “Hindi” via the user interface of the mobile device 110. Upon receiving a selection of the preferred languages, the application may be configured to store the selection and utilize it during the hands-free multi-lingual communication, as discussed throughout this disclosure. In various embodiments, the preferred language selection may be indicated via toggle switch or a drop down menu as also discussed later in FIGS. 4a and 4b of the present disclosure.

In an alternative embodiment, the users 102/112 may select more than one language as their preferred language. At the time of displaying or reading out the received messages from other mobile device 110, the application of the mobile device 104 may be configured to translate the message in one of the preferred languages. In an exemplary embodiment, the application may translate the message based on a current location of the user 102/mobile device 104. If the user 102 has preferred languages as English and Hindi, and if the user 102 is currently in India, then the received message may be translated into Hindi. Alternatively, if the user 102 is currently in his/her office location, then the message may be translated into English, else in Hindi.

In operation, the user 102 may initiate a hands-free communication with one of a plurality of contacts available via the application installed on the mobile device 104. In an exemplary embodiment, the application may be available as a social media chat application installed on the mobile device 104, and may reflect a plurality of contacts available to chat and sharing messages (text, audio, or video) among themselves. As a first step, the user 102 may provide a verbal message in a specific language via a microphone of the mobile device 104. In response to receiving the verbal message, the application may be configured to convert the verbal message into a textual message. In another embodiment, the application may be configured to record the verbal message as an audio file.

Further, in response to receiving the verbal message from the user 102, the application may be configured to receive a verbal command from the user 102. In one embodiment, the application may be configured to determine that the user 102 has provided a verbal command after providing the verbal message, based on detecting the device name in the spoken/verbal speech from the user 102. For example, after providing a verbal message “hi, how are you” for a user's contact, the user 102 may provide a verbal command “<<Device Name>> Send.” In response to detecting the verbal command, the application may be configured to match the verbal commands to the plurality of verbal commands pre-stored at the application. Upon detecting a match between the verbal command and one of the plurality of pre-stored commands, the associated action with the matched verbal command may be initiated. For example, upon detecting “<<Device Name>> SEND” as an input verbal command, the application at the mobile device 104 may be configured to send the verbal message to the other mobile device 110 via the network 108. The network 108 may include, but not limited to, any wired or wireless network such as radio network, LAN, or WAN which facilitates communication between two mobile devices.

Additionally, the application may be configured to receive another text input message at the mobile device 104 from the mobile device 110 in a specific language. Upon receipt of this another text message from the mobile device 110, the application may be configured to determine whether a toggle switch is on or off on the mobile device 104. In an exemplary embodiment, the toggle switch may be available to the user 102 via the user interface of the mobile device 104, which may indicate whether the user 102 requires his/her messages to be displayed/read in his/her preferred language. If the toggle switch is ON, the application may be configured to translate the received another text message into the preferred language of the user 102. For example, while the application at the mobile device 104 may receive a message in “Hindi” from the user 112 of the mobile device 110, the application may be configured to translate the message into the preferred language “English” of the user 102.

In one exemplary embodiment, the application at the mobile device 104 may be configured to translate the received message using a translator function available locally within the application. In an alternative embodiment, the application at the mobile device 104 may be configured to translate the received message using a translator function available at the cloud architecture 106.

In addition, the translated message may be displayed at the user interface of the mobile device 104. However, in case of receiving a verbal command from the user 102 to “READ OUT” the translated message, the application may read out the translated message out loud via the mobile device 104.

Accordingly, the system 100 facilitates in real-time translation of messages among users, and thereby providing a mechanism for real time multi-lingual communication. Thus, the invention facilitates in making the language barrier completely obsolete. In other words, the system 100 may provide for a seamless communication between users who do not share a common spoken language.

The system 100 may be implemented in various other embodiments. For example, the application may be configured to listen/receive any voice input instead of user 102's voice, such as a song, speech, video, and in response, the application may be configured to translate the received voice input. To implement the functionality, the user 102 may need to provide a verbal command immediately before the start of the voice input or after the voice input. The application may be useful in instances such as while flying, the passenger may use the application to translate the verbal instructions provided by the flight crew. Similarly, the application on the mobile device 104 may be configured to translate voice input of an ongoing audio/video call through another application on the phone. The voice input may be translated into text or audio into a user preferred language, thereby facilitating real-time multi-lingual communication amongst various users. The translated text or audio may be provided to the user 102 of the mobile device 104 itself, or it may be transmitted to another user or a group of users via SMS, social media message, etc.

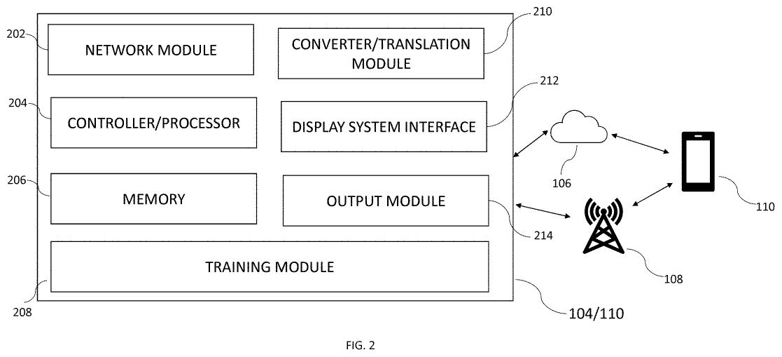

FIG. 2 illustrates a block diagram 200 depicting an architecture for implementing a hands-free multi-lingual online communication system in a mobile device 104, in accordance with some embodiments of the present invention.

The block diagram architecture 200 may comprise a network module 202, a controller/processor 204, a memory 206, a training module 208, a converter/translation module 210, a display system interface 212, and an output module 214.

The network module 202 may be configured to facilitate data exchange between the plurality of mobile devices, such as between mobile devices 104 and 110, or between mobile device 104/110 and the cloud architecture 106, or between the mobile device 104/110 and the network 108.

The controller/processor 204 controls operations of all components of the application at the mobile device 104/110, in accordance with various embodiment of the present invention. Specifically, the controller/processor 204 may be configured to execute program instructions stored in the memory 206 to perform the processes of the application of the mobile device 104/110. For example, the controller/processor 204 may be configured to train the application with verbal commands, receive and store a preferred language selection of the user, initiate a hands-free communication with one of the user contacts, receive a verbal message, receive a verbal command, determine status of toggle switch (whether ON or OFF), initiate translation of the received messages, transmit the messages, display/read the messages, etc.

The training module 208 may be configured to provide initial voice training for the application, upon initial installation. For example, the user 102 may be prompted via a user interface of the mobile device 104 to provide exemplary voice commands in order to train the application for recognizing user 102's voice commands in future. In one exemplary embodiment, the user may be prompted to provide verbal commands for sending a message by speaking “<<Device Name>> SEND.” Similarly, other verbal commands, such as, but not limited to, “<<Device Name>> READ” may be prompted for and set by the application. The device name may be separately set by the user 102. Further, the user 102 may be prompted to speak each command in a plurality of tones for better training of the application.

The converter/translation module 210 may be configured to translate the received messages locally within the application at the mobile device 104/110. In an alternative embodiment, converter/translation module 210 may be configured to translate the received messages using a translator function available at the cloud architecture 106.

The display system interface 212 may be configured to display the interface of the application at the mobile device 104/110. For example, the display system interface 212 may display the contact list, translated/non-translated messages, toggle switch, etc. in accordance with various embodiments of the present invention.

The output module 214 may be configured to output messages from the application of the mobile device 104/110 for transmitting to other mobile device 110/104 or reading out loud the messages from the mobile device 104/110, in accordance with various embodiments of the present invention.

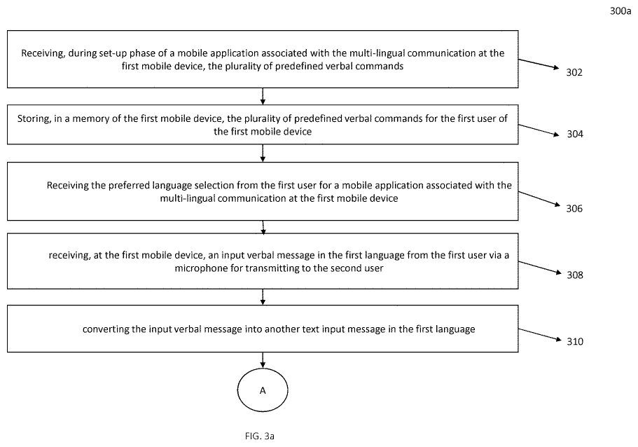

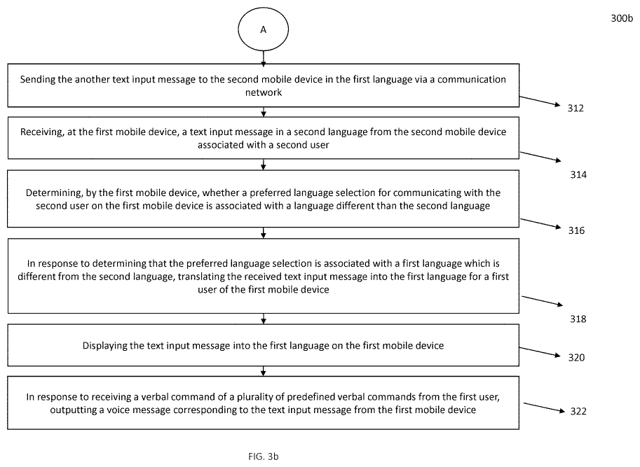

FIGS. 3a-3b illustrates process flow diagram depicting a method 300a-300b of operation of hands-free multi-lingual online communication system, in accordance with various embodiments of the present invention. The steps of the method 300a-300b may be performed at an application or more specifically at the mobile device 104 or 110. The system as illustrated in FIG. 2 for mobile device 104/110 may be used for performing steps of the method 300a-300b.

At step 302, the method 300 comprises receiving, during set-up phase of a mobile application associated with the multi-lingual communication at the first mobile device, the plurality of predefined verbal commands, each of the predefined verbal commands associated with performing a function related to one or more text input messages. The plurality of verbal commands may be configured as a part of initial voice training for the application, upon initial installation. For example, the user may be prompted via a user interface of the mobile device to provide exemplary voice commands in order to train the application for recognizing user's voice commands in future. In one exemplary embodiment, the user may be prompted to provide verbal commands for sending a message by speaking “<<Device Name>> SEND.” Similarly, other verbal commands, such as, but not limited to, “<<Device Name>> READ” may be prompted for and set by the application. The device name may be separately set by the user. Further, the user may be prompted to speak each command in a plurality of tones for better training of the application. Based on receiving each of the plurality of verbal commands from the user in a plurality of tones, the application may be configured to store these verbal commands in a memory to match the user's voice commands provided during hands-free communication via the application. Each of the verbal commands may be associated with an action. For example, the “<<Device Name>> SEND” may be associated with sending the message to another user.

At step 304, the method 300 comprises storing, in a memory of the first mobile device, the plurality of predefined verbal commands for the first user of the first mobile device.

At step 306, the method 300 comprises receiving the preferred language selection from the first user for a mobile application associated with the multi-lingual communication at the first mobile device. The preferred language selection is one of commonly received for communication in a plurality of chat windows associated with a plurality of users of the mobile application or separately received for communication in each chat window of the plurality of chat windows associated with the plurality of users of the mobile application. In an embodiment, receiving the preferred language selection comprises one of receiving an input via a toggle switch displayed at a user interface of the mobile application, and receiving a selection of the preferred language via a drop down menu comprising a plurality of languages.

The user interface of the mobile device may display a list of available languages pre-stored at the application. In response to displaying the list, the user may select their respective preferred languages. For example, the user may select “English” via the user interface of the mobile device. Upon receiving a selection of the preferred language, the application may be configured to store the selection and utilize it during the hands-free multi-lingual communication, as discussed throughout this disclosure.

In an alternative embodiment, the users may select more than one language as their preferred language. At the time of displaying or reading out the received messages from other mobile device, the application of the mobile device may be configured to translate the message in one of the preferred languages. In an exemplary embodiment, the application may translate the message based on a current location of the user/mobile device. If the user has preferred languages as English and Hindi, and if the user is currently in India, then the received message may be translated into Hindi. Alternatively, if the user is currently in his/her office location, then the message may be translated into English, else in Hindi.

At step 308, the method 300 comprises receiving, at the first mobile device, an input verbal message in the first language from the first user via a microphone for transmitting to the second user. The input verbal message may be received in first language from the user via a microphone for transmitting to another user.

At step 310, the method 300 comprises converting the input verbal message into another text input message in the first language. In another embodiment, the application may be configured to record the verbal message as an audio file.

At step 312, the method 300 comprises in response to receiving another verbal command of the plurality of predefined verbal commands, sending the another text input message to the second mobile device in the first language via a communication network. Specifically, a verbal command of the plurality of verbal commands may be received. Subsequently, based on receipt of the verbal command, the text message may be transmitted to a second mobile device in the first language via a network. In one embodiment, the application may be configured to determine that the user has provided a verbal command after providing the verbal message, based on detecting the device name in the spoken/verbal speech from the user. For example, after providing a verbal message “hi, how are you” for a user's contact, the user may provide a verbal command “<<Device Name>> Send.” In response to detecting the verbal command, the application may be configured to match the verbal commands to the plurality of verbal commands pre-stored at the application. Upon detecting a match between the verbal command and one of the plurality of pre-stored commands, the associated action with the matched verbal command may be initiated. For example, upon detecting “<<Device Name>> SEND” as an input verbal command, the application at the mobile device may be configured to send the verbal message to the other mobile device via the network. The network may include, but not limited to, any wired or wireless network such as radio network, LAN, or WAN which facilitates communication between two mobile devices.

At step 314, the method 300 comprises receiving, at the first mobile device, a text input message in a second language from the second mobile device associated with a second user. In an embodiment, the step 314 may be performed as a first step in the method 300. Specifically, some or all of the steps 302-312 may not be performed before step 314.

At step 316, the method 300 comprises in response to receiving the text input message from the second mobile device associated with the second user, determining, by the first mobile device, whether a preferred language selection for communicating with the second user on the first mobile device is associated with a language different than the second language. In an embodiment, determining the preferred language selection for communicating with the second user on the first mobile device comprises determining one of a state of toggle switch and a selection of the preferred language in the drop down menu. Specifically, upon receipt of this another text message from the another mobile device, the application may be configured to determine whether a toggle switch is ON or OFF on the mobile device. Alternatively, a drop down menu option may be checked to identify preferred language for the user receiving the message. In an exemplary embodiment, the toggle switch may be available to the user via the user interface of the mobile device, which may indicate whether the user requires his/her messages to be displayed/read in his/her preferred language. In ye another embodiment, determining the preferred language selection for communicating with the second user on the first mobile device comprises determining the preferred language selection based on a current location of the first user of the first mobile device.

At step 318, the method 300 comprises in response to determining that the preferred language selection is associated with a first language which is different from the second language, translating the received text input message into the first language for a first user of the first mobile device.

If the toggle switch is ON, the application may be configured to translate the received another text message into the preferred language of the user. For example, while the application at the mobile device may receive a message in “Hindi” from the user of the mobile device, the application may be configured to translate the message into the preferred language “English” of the user.

At step 320, the method 300 comprises displaying the text input message into the first language on the first mobile device. Accordingly, the text message may be displayed into the preferred language on the mobile device.

At step 322, the method 300 comprises in response to receiving a verbal command of a plurality of predefined verbal commands from the first user, outputting a voice message corresponding to the text input message from the first mobile device. Accordingly, in response to receiving a verbal command, the text message is read out loud on the first mobile device.

FIGS. 4a and 4b illustrate exemplary user interfaces 402 of the hands-free multi-lingual online communication system implemented at a mobile device 104, in accordance with various embodiments of the present invention. The user interface 402 depicts a chat screen of the application, while chatting with another user.

Referring to FIG. 4A, according to one embodiment, the user interface 402 may comprise a top window 404, a chat display window 422, and a bottom window 420. The top window 404 may include a display picture of another user with whom the user of device 104 is currently chatting, name of another user, status (whether online or offline) of another user, icons 406 and 408 to make video and audio calls respectively, and a toggle switch 410. The toggle switch 410 may be either in switched ON or OFF mode based on user's input. When the toggle switch is ON, it indicates that the user of the device 104 requires received messages from another user to be displayed or read out in his/her preferred language, irrespective of the language in which the messages are received from the other user.

The chat display window 422 may include an area for displaying chat messages received and send to/from another user.

The bottom window 420 may include an icon 412 to send different types of content, such as video, pdfs, documents, contact details, etc. The bottom window 420 may further include area 414 to type messages, icon 416 to share pictures, icon 418 to send voice messages and voice commands.

Referring to FIG. 4b, the top window may include a drop down menu 410 instead of a toggle switch indicated in FIG. 4a. The preferred language selection may be performed using the drop down menu. The drop down menu or the toggle switch may be available for each chat window associated with a particular user in the mobile application. Alternatively, the preferred language selection may be performed for all the chat windows or users of the mobile application through a settings option of the mobile application at the user device.

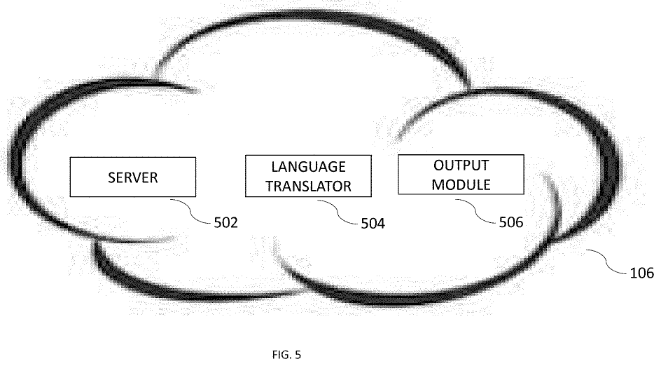

FIG. 5 illustrates an exemplary cloud architecture 106 for implementation of for hands-free multi-lingual online communication, in accordance with some embodiments of the present invention.

The cloud architecture 106 may include a server 502, a language translator 504, and an output module 506. In one embodiment, the application at the mobile device 104 may be configured to translate the received message using a language translator 504 available at the cloud architecture 106. The server 502 may be configured to receive a message for translation from a mobile device 104/110, as depicted in FIG. 1. Additionally, the server may receive an indicator to indicate the desired language of translation. The server 502 in combination with the language translator 504 may be configured to translate the message into the desired language. Further, the output module 506 may be configured to transmit the translated message back to the mobile device which transmitted the initial non-translated message. The translated message is subsequently received by the mobile device (e.g., mobile device 104) and displayed or read out loud based on the preference/input of the user.

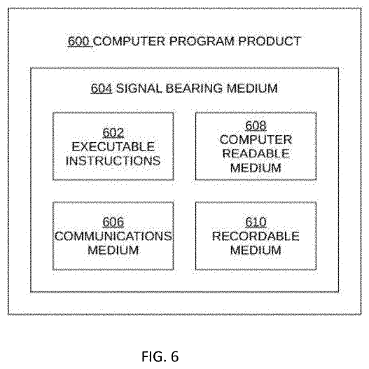

FIG. 6 illustrates an exemplary computer program product 600 that is configured to provide hands-free multi-lingual online communication, in accordance with various embodiments of the present invention.

The computer program product 600 may correspond to a program product stored in memory 206 or a program product stored in the form of processor executable instructions stored in mobile device 104/110.

Computer program product 600 may include a signal bearing medium 604. Signal bearing medium 604 may include one or more instructions 602 that, when executed by, for example, a processor or controller, may provide the functionalities described above to perform hands-free multi-lingual online communication.

In some implementations, signal bearing medium 604 may encompass a computer-readable medium 608, such as, but not limited to, a hard disk drive, a Compact Disc (CD), a Digital Video Disk (DVD), a digital tape, memory, etc. In some implementations, signal bearing medium 604 may encompass a recordable medium 610, such as, but not limited to, memory, read/write (R/W) CDs, R/W DVDs, etc. In some implementations, signal bearing medium 604 may encompass a communications medium 606, such as, but not limited to, a digital and/or an analog communication medium (e.g., a fiber optic cable, a waveguide, a wired communications link, a wireless communication link, etc.). Thus, for example, program product 600 may be conveyed to one or more components of the control unit 60 or mobile device 31 by an RF signal bearing medium 604, where the signal bearing medium 604 is conveyed by a wireless communications medium 606 (e.g., a wireless communications medium conforming with the IEEE 802.11 standard).

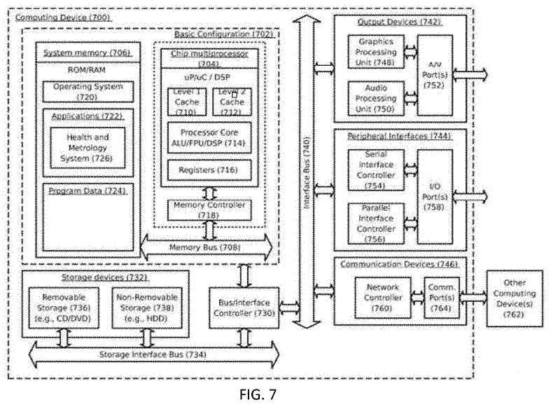

FIG. 7 is a block diagram illustrating an exemplary computing device that is configured to provide hands-free multi-lingual online communication, in accordance with various embodiments of the present invention. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (p,P), a microcontroller (piC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof System memory 706 may include an operating system 720, one or more applications 722, and program data 724. Application 722 may include a document interaction evaluation algorithm 726 that is arranged to perform the functions as described herein including those described with respect to system 100 of FIGS. 1-6. Program data 724 may include document interaction evaluation data 728 that may be useful for implementation of a document interaction evaluator based on an ontology as is described herein. In some embodiments, application 722 may be arranged to operate with program data 724 on operating system 720 such that implementations of evaluating interaction with document based on ontology may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more AN ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

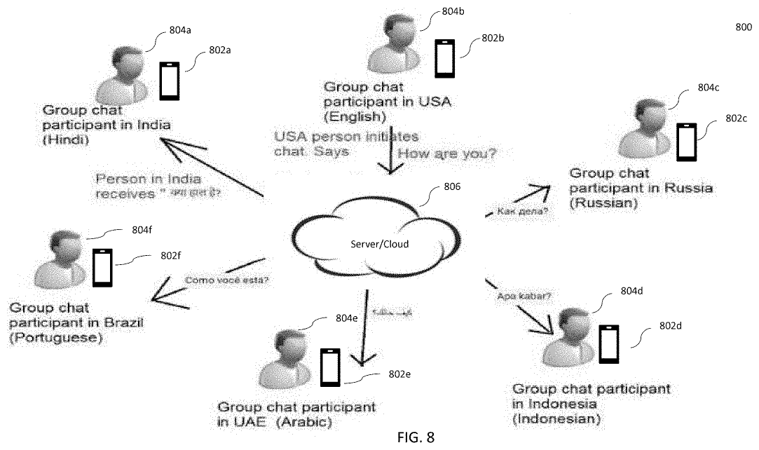

FIG. 8 provides a system for hands-free multi-lingual online communication among a plurality of users in a group chat window of a mobile application, according to an embodiment of the present invention. In accordance with the an embodiment of the present invention, the system 800 may include mobile devices 802a-802f, users 804a-804f, ana cloud/server architecture 806.

According to one embodiment of the present invention, each of the mobile devices 802a-802f may include an application installed therein. The application may comprise computer processor executable instructions, which upon execution, are configured to provide a hands-free multi-lingual online communication with another mobile device (or user of the mobile device). In another embodiment, the hands-free multi-lingual online communication may be configured to be accessed via a website available through a web-browser on the mobile devices 802a-802f. While the Figure depicts the mobile devices 802a-802f, it may be apparent to a person skilled in the art that the mobile devices 802a-802f may include any electronic communication device capable of installation of a mobile application or running a web browser to access internet. For example, the mobile devices 802a-802f may include, but not limited to, a mobile communication device, smart watch, a laptop, a desktop, tablet, etc.

As also discussed with respect to FIG. 1, the application installed at the mobile devices 802a-802f may be configured to store a plurality of verbal commands for the users 804a-804f of the respective devices. The plurality of verbal commands may be configured as a part of initial voice training for the application, upon initial installation. Each of the verbal commands may be associated with an action to be performed on the mobile application associated with the chat or text/verbal messages.

Further, the application installed at the mobile devices 802a-802f may be configured to prompt, via the user interface of the application at the mobile device, to receive a preferred language selection from the users 804a-804f The user interface of the mobile devices 802a-802f may display a list of available languages pre-stored at the application. In response to displaying the list, the users 804a-804f may select their respective preferred languages. Upon receiving a selection of the preferred languages, the application may be configured to store the selection and utilize it during the hands-free multi-lingual communication, as discussed throughout this disclosure.

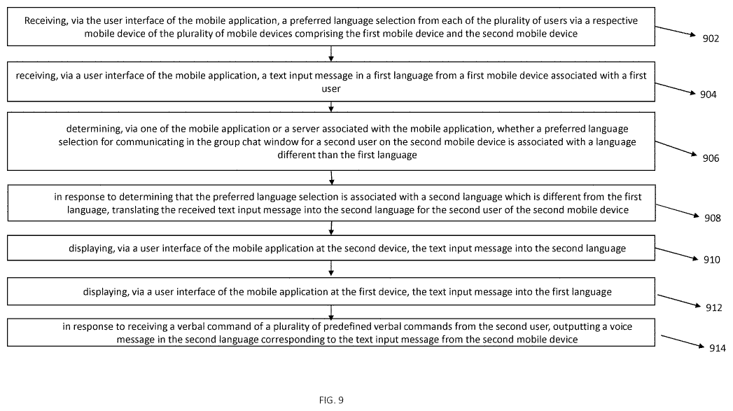

In operation, the system 800 may be used for for hands-free multi-lingual online communication among the plurality of users 804a-804f simultaneously in a group chat window of a mobile application. The group chat may be an interface at the mobile application for communicating via text/verbal messages simultaneously via a communication network (not shown) through cloud/server architecture 806. Each mobile device 802a-802f may further include a system comprising a memory which comprises computer executable instructions, and a processor configured to execute the computer executable instructions to perform one or more functions to facilitate group chat communication among various users 804a-804f The steps performed at each mobile device 802a-802f are discussed in conjunction with FIG. 9.

FIG. 9 illustrates flow diagram 900 depicting a method 900 for hands-free multi-lingual online communication among a plurality of users in a group chat window of a mobile application, according to an embodiment of the present invention. The steps of the method may be performed at each of the mobile device 802a-802f and/or at the server/cloud architecture 806 to facilitate group communication among users 804a-804f, and more particularly via a system inside each mobile device 802a-802f, such as the system disclosed in FIG. 2.

At step 902, the method 900 comprises receiving, via the user interface of the mobile application, a preferred language selection from each of the plurality of users via a respective mobile device of the plurality of mobile devices comprising the first mobile device and the second mobile device. The preferred language selection may be stored locally for each user or each mobile device or at the server/cloud 806. The preferred language selection may indicate a language preference of the user receiving the text/verbal messages from other users. Even while the language in which the messages are received from other uses are in a non-preferred language, the preferred language selection may be used as a trigger to translate the messages into the preferred language of the user reading the message at his/her mobile device only.

At step 904, the method 900 comprises receiving, via a user interface of the mobile application, a text input message in a first language from a first mobile device associated with a first user. The message may be only received, but may not be displayed in the first language. Further steps may be performed to determine preferred language of the user receiving the message and translate the message in the user preferred language.

At step 906, the method 900 comprises in response to receipt of the text input message from the first mobile device associated with the first user, determining, via one of the mobile application or a server associated with the mobile application, whether a preferred language selection for communicating in the group chat window for a second user on the second mobile device is associated with a language different than the first language.

At step 908, the method 900 comprises in response to determining that the preferred language selection is associated with a second language which is different from the first language, translating the received text input message into the second language for the second user of the second mobile device. The translation may be performed either locally at the mobile application of the mobile device receiving the message, or at the cloud/server 806. The mobile device receiving the message may receive in the translated language which is the preferred language of the user receiving the message. The determination and/or translation may be performed based on a state of toggle switch (ON or OFF) or a preferred language selection indicated in a drop down menu of the user interface of the mobile application.

At step 910, the method 900 comprises displaying, via a user interface of the mobile application at the second device, the text input message into the second language, i.e., the preferred language of the user.

At step 910, the method 900 comprises displaying, via a user interface of the mobile application at the first device, the text input message into the first language.

At step 912, the method 900 comprises in response to receiving a verbal command of a plurality of predefined verbal commands from the second user, outputting a voice message in the second language corresponding to the text input message from the second mobile device. Similarly, the first user may also provide a verbal command to output the message in voice form.

Some aspects already discussed with respect to FIGS. 1-3 are not discussed again in detail for FIGS. 8 and 9. As may be appreciated, the features of FIGS. 1-3 are discussed with respect to a single mobile device, while the features of FIGS. 8-9 are with respect to multiple devices communicating over a group chat and hence, most of the features implemented for a single mobile device may be common and replicated for multiple devices in a group chat.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

I claim:

1. A method for hands-free multi-lingual online communication between a first mobile device and a second mobile device, the method comprising:
receiving, at the first mobile device, a text input message in a second language from the second mobile device associated with a second user;
in response to receiving the text input message from the second mobile device associated with the second user, determining, by the first mobile device, whether a preferred language selection for communicating with the second user on the first mobile device is associated with a language different than the second language;
in response to determining that the preferred language selection is associated with a first language which is different from the second language, translating the received text input message into the first language for a first user of the first mobile device;
displaying the text input message into the first language on the first mobile device; and
in response to receiving a verbal command of a plurality of predefined verbal commands from the first user, outputting a voice message corresponding to the text input message from the first mobile device.

2. The method of claim 1 further comprising:
receiving, at the first mobile device, an input verbal message in the first language from the first user via a microphone for transmitting to the second user;
converting the input verbal message into another text input message in the first language; and
in response to receiving another verbal command of the plurality of predefined verbal commands, sending the another text input message to the second mobile device in the first language via a communication network.

3. The method of claim 1 further comprising:
receiving, during set-up phase of a mobile application associated with the multi-lingual communication at the first mobile device, the plurality of predefined verbal commands, each of the predefined verbal commands associated with performing a function related to one or more text input messages; and
storing, in a memory of the first mobile device, the plurality of predefined verbal commands for the first user of the first mobile device.

4. The method of claim 1, further comprising:
receiving the preferred language selection from the first user for a mobile application associated with the multi-lingual communication at the first mobile device, wherein the preferred language selection is one of commonly received for communication in a plurality of chat windows associated with a plurality of users of the mobile application or separately received for communication in each chat window of the plurality of chat windows associated with the plurality of users of the mobile application.

5. The method of claim 4, wherein receiving the preferred language selection comprises one of:
receiving an input via a toggle switch displayed at a user interface of the mobile application; and
receiving a selection of the preferred language via a drop down menu comprising a plurality of languages.

6. The method of claim 5, wherein determining the preferred language selection for communicating with the second user on the first mobile device comprises determining one of a state of toggle switch and a selection of the preferred language in the drop down menu.

7. The method of claim 1, wherein determining the preferred language selection for communicating with the second user on the first mobile device comprises determining the preferred language selection based on a current location of the first user of the first mobile device.

8. A method for hands-free multi-lingual online communication among a plurality of users in a group chat window of a mobile application, the method comprising:
receiving, via a user interface of the mobile application, a text input message in a first language from a first mobile device associated with a first user;
in response to receiving the text input message from the first mobile device associated with the first user, determining, via one of the mobile application or a server associated with the mobile application, whether a preferred language selection for communicating in the group chat window for a second user on the second mobile device is associated with a language different than the first language;
in response to determining that the preferred language selection is associated with a second language which is different from the first language, translating the received text input message into the second language for the second user of the second mobile device;
displaying, via a user interface of the mobile application at the second device, the text input message into the second language; and
displaying, via a user interface of the mobile application at the first device, the text input message into the first language.

9. The method as claimed in claim 8 further comprising:
in response to receiving a verbal command of a plurality of predefined verbal commands from the second user, outputting a voice message in the second language corresponding to the text input message from the second mobile device.

10. The method as claimed in claim 8 further comprising:
receiving, via the user interface of the mobile application, a preferred language selection from each of the plurality of users via a respective mobile device of the plurality of mobile devices comprising the first mobile device and the second mobile device.

11. A system for hands-free multi-lingual online communication between a first mobile device and a second mobile device, the system comprising:
a memory comprising computer executable instructions; and
a processor configured to execute the computer executable instructions to:
receive, at the first mobile device, a text input message in a second language from the second mobile device associated with a second user;
in response to receipt of the text input message from the second mobile device associated with the second user, determine, by the first mobile device, whether a preferred language selection for communicating with the second user on the first mobile device is associated with a language different than the second language;
in response to a determination that the preferred language selection is associated with a first language which is different from the second language, translating the received text input message into the first language for a first user of the first mobile device;
display the text input message into the first language on the first mobile device; and
in response to receipt of a verbal command of a plurality of predefined verbal commands from the first user, output a voice message corresponding to the text input message from the first mobile device.
